(19) United States
(12) Patent Application Publication
(10) Pub. No.: US 2014/0285936 A1
(43) Pub. Date: Sep. 25, 2014

(54) BATTERY MANAGEMENT SYSTEM FOR ELECTRIC VEHICLE

(71) Applicant: MAGNA E-CAR SYSTEMS OF AMERICA, INC., Auburn Hills, MI (US)

(72) Inventors: Neil R. Garbacik, Rochester Hills, MI (US); Stephen L. Pudvay, Howell, MI (US); John R. Collier, Orion, MI (US); Qi Tao, Canton, MI (US); Oscar Flores, Macomb, MI (US)

(73) Assignee: MAGNA E-CAR SYSTEMS OF AMERICA, INC., Auburn Hills, MI (US)

(21) Appl. No.: 14/203,617

(22) Filed: Mar. 11, 2014

Related U.S. Application Data
(60) Provisional application No. 61/803,635, filed on Mar. 20, 2013.

(51) Int. Cl. B60L 11/18; H02J 7/00

(52) U.S. Cl. CPC B60L 11/1866; H02J 7/0031
USPC 361/88

(57) ABSTRACT

A battery management system for a vehicle having an electrically powered motor that is powered by a plurality of battery cells includes an electrical system for providing voltage and current from the battery cells to an electrical motor. A control is operable to at least one of (a) cause fuses of the electrical system to be the weakest link in the electrical system only during a failure event, (b) disconnect the battery cells from the battery management system only during a failure event, (c) separate the driving of balancing resistors into first and second stages, with the first stage comprising cell balancing control and the second stage comprising cell balancing with reverse voltage protection and (d) provide single stage reverse voltage protection to limit or effectively eliminate an electrical conduction path through a low impedance balancing circuit.

### CROSS REFERENCE TO RELATED APPLICATION

The present application claims the filing benefits of U.S. provisional application Ser. No. 61/803,635, filed Mar. 20, 2013, which is hereby incorporated herein by reference in its entirety.

### FIELD OF THE INVENTION

The present invention relates generally to electric vehicles and, more particularly, to batteries and battery management of batteries for an electric vehicle.

### BACKGROUND OF THE INVENTION

Electric vehicles use electric motors that are operated by converted electrical energy output from a battery pack. These electric vehicles use battery packs that have a plurality of rechargeable battery cells (formed into a pack or module) as a main power source. A voltage of tens of volts to several hundred volts is typically used in powering a secondary or main propulsion motor in an electric vehicle. However, individual battery units/cells provide a relatively low nominal DC voltage (for example, for a Lithium ion battery, a cell voltage in the 3 volt to 4.2 volt range is typical; a lithium nickel manganese cobalt oxide (NMC) battery cell can have around 3.7 volts across its output terminals and a LiFePO4 cell can have a nominal voltage around 3.2 V). Thus, a plurality of such individual cells needs be connected electrically in series or a series-parallel configuration to provide a high enough voltage and/or power density to meet the needs of the likes of the main propulsion motor in an electrically-powered vehicle.

In such a battery-powered electric vehicle, the performance of the battery cells/battery pack directly influences the performance of the vehicle. Therefore, a battery management system (BMS) that efficiently manages the charge and discharge of the battery or batteries, such as by measuring the battery cell voltages and/or current, is provided, such as are disclosed in U.S. Pat. Nos. 8,344,694; 8,315,828; 8,307,223; 8,299,757; 8,273,474; 8,264,201; 8,232,886; 8,174,240; 8,164,305; 8,134,340; 8,134,338; 8,111,071; 8,060,322; 8,054,034; and/or 8,004,249, which are hereby incorporated herein by reference in their entireties. A battery management system or electric vehicle may include a thermal management system for the batteries, such as by utilizing aspects of the systems described in PCT Application No. PCT/US2011/051673, filed Sep. 15, 2011 and published Mar. 29, 2012 as International Publication No. WO 2012/040022, which is hereby incorporated herein by reference in its entirety.

### SUMMARY OF THE INVENTION

The present invention provides a battery management system for a vehicle having an electrically powered motor that is powered by a battery unit or module having a plurality of individual batteries arranged in a series configuration or series-parallel configuration. The battery management system includes or is associated with an electrical system for providing voltage and current from an energy source, such as a plurality of batteries, to excite an electrical motor. The battery management system includes a control or circuitry or failure mitigation strategy that is operable to at least one of (a) force cell sense line fuses of the electrical system to be the weakest link in the electrical system only during a failure event to effectively disconnect the energy source or batteries from the battery management system, (b) forcibly disconnect the energy source or batteries from the battery management system in applications where the electrical system does not include fuses for each cell voltage sense line, (c) separate the driving of balancing resistors into two stages, with the first stage comprising cell balancing control and the second stage comprising cell balancing with reverse voltage protection and (d) provide single stage reverse voltage protection to effectively eliminate an electrical conduction path through a low impedance balancing circuit.

These and other objects, advantages, purposes and features of the present invention will become apparent upon review of the following specification in conjunction with the drawings.

### BRIEF DESCRIPTION OF THE DRAWINGS

FIG. 1 is a schematic of a known battery system, shown with fuses in sense lines;

FIG. 2 is a schematic of the present invention, showing a diode network which only becomes active in a reverse voltage scenario (potentially caused by but not limited to a high impedance open cell, a broken cell interconnecting bus bar or cross wiring of the system or the like), providing a current path by-passing the battery voltage sensing ASIC (balancing FETs and 12 ohm resistive network) and therefore destroying the fuses in the sense leads within seconds of the failure mode occurring;

FIG. 3 is another schematic of the present invention, shown with a diode network which only becomes active in a reverse voltage (high impedance open cell, broken bus bar or cross wiring) scenario providing a current path by-passing the ASIC (balancing FETs and 12 ohm resistive network) and therefore destroying the fusible devices inside the module designated by R17-R29;

FIG. 4 is a BCECU (Battery Cell Electronic Control Unit) SN0075 temperature profile of the BCECU ASIC and sequence of events on a known design during a broken bus bar weld/open cell failure mode, showing that a maximum temperature of about 463 degrees C. was reached prior to human intervention to physically disconnecting the cell sense leads from the energy source to remove the energy and in turn cease the system thermal event/reaction;

FIG. 5 is a simplified schematic of two-BCECU battery management system with 12 battery cells per BCECU during a known cell balancing process on CELL 5;

FIG. 6 is a schematic of a known system where there is an open battery cell (between CELL 5 and CELL 6 in FIG. 6), showing a high power loss on 1210 balancing resistors leading to significant thermal event when there is the open battery cell;

FIG. 7 is a schematic of the system of the present invention, showing two stages balancing;

FIG. 8 is a schematic of the system of the present invention, showing an example of the two stages balancing concept during normal balancing operation, with the balancing resistors comprising 1210 surface mount resistors and the other resistors comprising 0603 resistors);

FIG. 9 is a schematic of the system of the present invention, showing an exemplary system during an initial stage of an open battery cell;

FIG. 10 is a schematic of the system of the present invention, showing an exemplary system during a second stage of an open battery cell;

FIG. 11 is a schematic of the system of the present invention, showing an exemplary system at a last stage of reverse diode protection;

FIG. 12 is a schematic showing parts integration; and

FIG. 13 is a schematic showing a method of utilizing blocking diodes to withstand a high reverse voltage and effectively limit or eliminate a conduction path during the system failure conditions.

### DESCRIPTION OF THE PREFERRED EMBODIMENTS

For a battery system of an electric vehicle or the like, the likes of charge/discharge levels, diagnostics, thermal management, short-circuit protection and over-temperature protection is provided by a battery management system (BMS). Thus, in an electric vehicle, a battery pack (sometimes referred to as a battery module) includes a plurality of secondary batteries (each sometimes referred to as unit battery) electrically coupled in a series configuration or a series-parallel configuration. In the likes of a hybrid electric vehicle (HEV), several to tens of unit batteries are alternately recharged and discharged. It is desirable that the charge/discharge operation of the battery module be controlled so as to maintain the battery module in an appropriate operational mode.

For example, when the battery pack/module is charged and used, the respective unit batteries forming the battery pack/module are repeatedly charged and discharged, during which energy levels of the respective unit batteries may become different from each other.

When a plurality of unit batteries electrically coupled in series or series-parallel configuration are recharged after they are once discharged (i.e., used) to different energy levels, the energy levels of the recharged unit batteries may also be different from each other. In such a case, when the charge and discharge operations are repeatedly performed, some of the unit batteries forming a group may be over-discharged so that the output potentials vary widely between all of the cells, thus causing an undesired imbalance within the battery pack. When a user continuously uses the over-discharged unit batteries and discharges them, a battery cell may be damaged, mechanically breaking down the internal components, and thus creating an instability or a reduced performance of the battery pack.

Thus, when unit batteries having different respective energy levels are electrically coupled in a group and charged, the unit batteries having higher energy levels indicate a charge completion to a charger before the unit batteries having lower energy levels are fully charged, and the charger consequentially may prematurely finish the charge operation. In addition, when the battery pack/module includes the over-discharged unit battery sets, the unit batteries other than the over-discharged unit battery may be over-charged before the over-discharged unit battery set is fully charged. That is, the incomplete charge and over-discharge operations may be repeatedly performed in some of the plurality of unit batteries, and the complete charge or over-charge and incomplete discharge operations are repeatedly performed on the others of the plurality of unit batteries, and therefore the unit batteries may be damaged.

Therefore, to reduce damage of the unit batteries, a known secondary battery pack/module includes a BMS for managing states of the respective unit batteries and a switch (such as a relay, contactor, or other solid state switch device or the like) for controlling current transmission when the battery pack/module is in a faulted state or when energy transfer is not needed. The BMS detects voltages of the respective unit batteries in the battery pack/module. The BMS controls the relay to perform a cut-off operation when the detected voltage of the unit battery is higher or lower than a cut-off voltage. If there is a hazardous condition occurring or imminent, the BMS may cut off the current of the battery pack/module and recover the unit battery.

The present invention protects the batteries and battery management system of an electric vehicle from weaknesses that are typical in currently known battery management systems. Lithium Ion batteries have a significant amount of safety related controversy following them in the vehicle industry. The search for an alternative energy has been a significant focus with the increase in society's environmental consciousness and also with the impacts of the theory of peak oil and the public's transportation costs associated with this phenomenon. With this comes safety concerns and how the vehicle monitors and controls different states of an alternative energy, such as Lithium based energy, to make it a useful and safe alternative for the public.

Typically, battery management systems utilize an ASIC (application specific integrated circuit) with high impedance voltage sense analog monitoring circuits for cell voltage monitoring (typically monitors 4-12 cells per ASIC) and additional analog inputs for temperature sensing. In addition to the two functions of the safety monitoring of voltages and temperatures, the battery management system also employs a strategy to maintain cell voltage balance within a battery pack between the unit batteries. The balancing circuit is typically a switched low impedance circuit, which is utilized to bleed off charge from the highest potential cells in order to ensure that cell voltages in a battery pack are relatively equal to the voltage potential of the lowest voltage cell in the battery pack, essentially balancing the battery pack. This method is known to the industry as “passive balancing.” The switched circuit is a parallel circuit to the voltage sense circuit and typically shares the same electronic path to dissipate battery cell charge as well as measure the cell voltage potential.

There is another method of balancing that is known to the industry as “active balancing,” where charge is shuttled between cells, hence charging the lower voltage cells and discharging higher voltage cells. The lowest cell voltage is no longer the target cell voltage potential for the entire battery pack when active balancing is employed. For the purpose of simplicity, the discussion below focuses on passive balancing. However, it is envisioned that aspects of the present invention may also apply to an active balancing architecture.

There are a number of electronic switching concepts which may be employed to switch the passive balance impedances in parallel to the battery cell. A summary of different switch concepts and what is actually feasibly controllable to employ in a design is described.

Bidirectional Conducting Bidirectional Blocking—Ideal Switch

Forward Conducting Reverse Blocking—Diode

Forward Conducting Forward Blocking—Bipolar junction Transistor (BJT)

Forward Conducting Bidirectional Blocking—Gate Turn Off Thyristor (GTO)

Bidirectional Conducting Forward Blocking—Field Effect Transistor (FET)

The Ideal Switch is the ideal method of controlling the dissipation of a cell for balancing. There is full control over the current flow and it can be blocked in either direction. Ideal is typically not an option, as there are semiconductors in use and the properties may vary as shown above.

The most feasible and cost effective options are controllable switches employed in present designs are BJTs and FETs. FETs are utilized internal to ASICs due to the low Rds_on and the less heat dissipation (higher efficiency). BJTs are utilized normally if the balancing current requirement is too large for the ASIC to handle. The downfall of a FET is when it becomes reverse biased it may conduct in the reverse direction due to the intrinsic body diode, and when the balancing circuit is in parallel to the high impedance input of the voltage sense, the lowest impedance conduction path is through the balancing impedances.

The failure mode which is typical with known or employed battery pack technology is a damaged cell which has a high impedance property (or open circuit), a battery bus bar or weld failure between two series connected cells or an incorrect wire harness configuration, all of which will result in a reverse voltage seen by the BCECU. When any of these failure scenarios occurs and there is a load on the battery pack, the main current path is considered open and the lowest impedance path is now the battery management ASIC and associated circuitry. The other side effect is that there becomes a reverse full pack voltage less one cell potential across the two cell sense lines which are adjacent to the failure. This high reverse voltage forward biases the FET's intrinsic body diode and creates a conduction path through the balancing FET and its associated low impedance balance circuitry.

The cell sense voltage potential below the failed cell or bus bar is always a significantly higher potential than the cell sense voltage potentials above the point of failure and, therefore, any diode paths which are normally reverse biased are now forward biased leading to more unexpected conduction paths. Depending on the design of the ASIC and associated circuitry, there may be more reverse conduction sneak paths due to the reverse voltages the ASIC is experiencing during a failure, thus leading to a catastrophic failure event which at a minimum may lead to the balance resistors and the ASIC to rise significantly in temperature which may lead to carbonization of the PCB and a thermal runaway of the product.

Due to the physics of the failure and the battery monitoring design, the worst case event may be a fire and this circles back to safety mitigation methods and the recent controversies concerning the known Lithium based energy storage technologies which are out in the public realm.

One safety mitigation technique that may be employed by the vehicle manufacturers is cell voltage sense line fusing. The sole purpose of the fuses is to disconnect the energy source and prevent further damage or uncontrolled chain reactions. This mitigation works only when the fuse is the weakest link in the system, but in all reality, the known fuses can handle more current for longer durations than some of the components in the balancing circuit. This technique is also a careful balance between design related to inrush current management and a fusing strategy. When selecting fuses, they are typically selected to give significant design margin to prevent false open circuits during the battery pack operational life, during initial assembly and service assembly (to handle inrush currents upon connection).

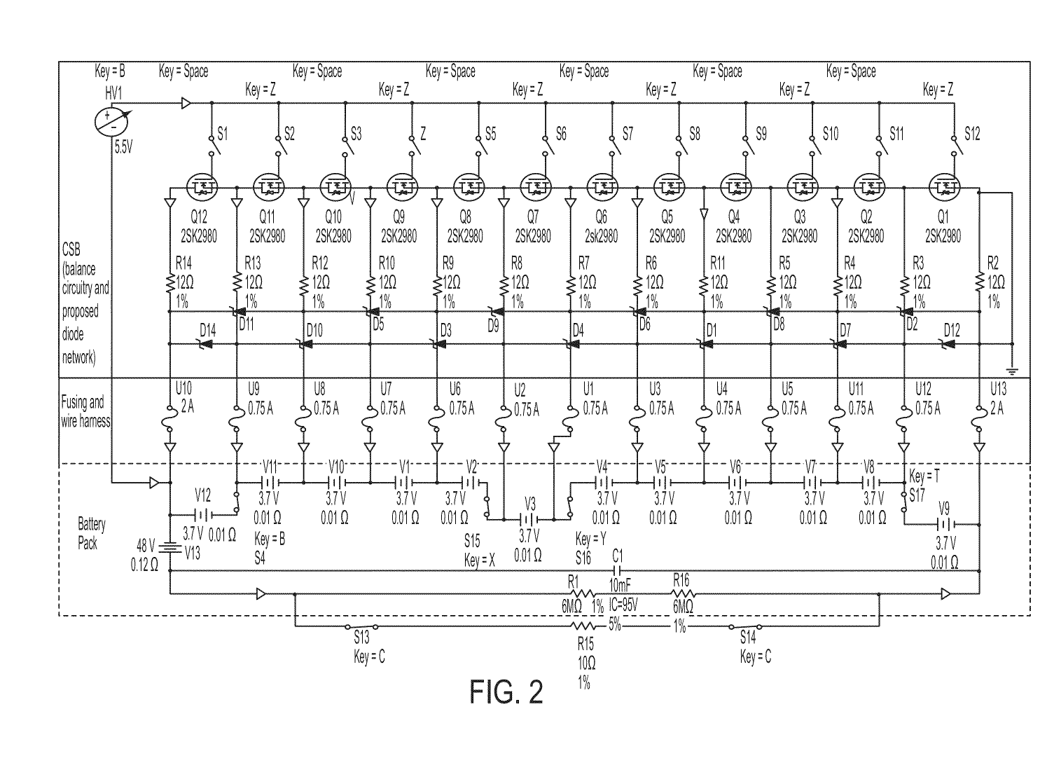

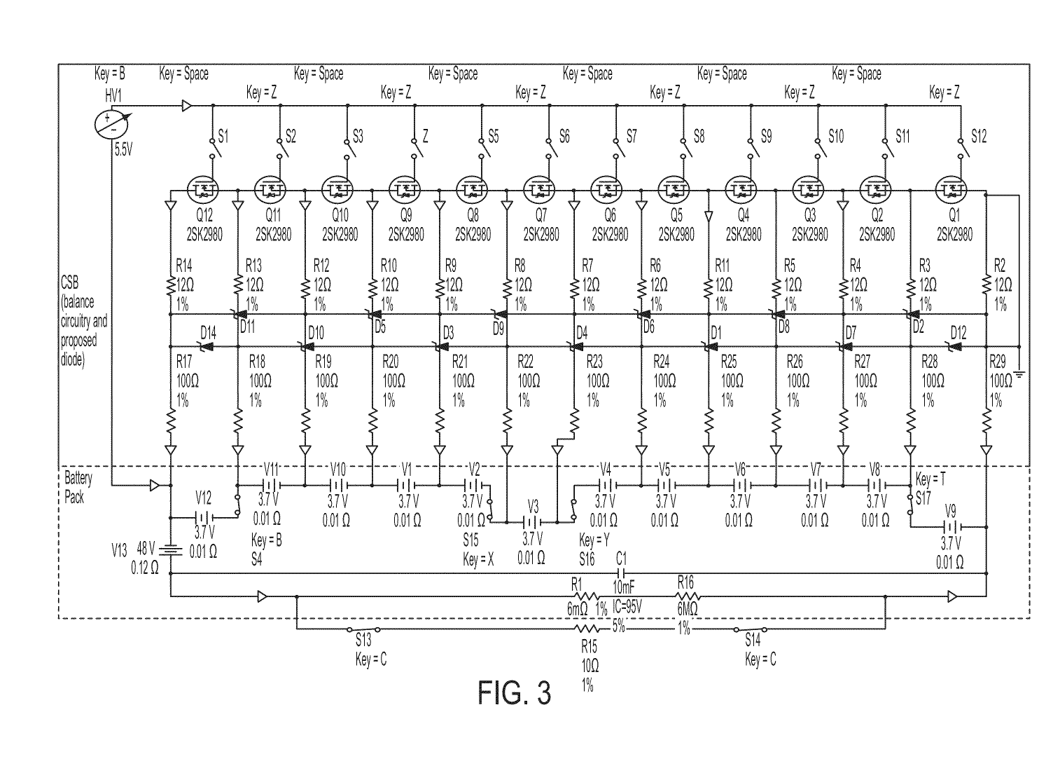

The present invention provides a system or systems that will significantly decrease the severity of a failure modes open circuit battery cell, incorrect wiring harness or broken battery bus bar weld. One aspect of the present invention addresses forcibly blowing the fuses if the system is equipped with cell sense line fuses. The present invention uniquely uses the basic switch theory described above as well as shown in FIG. 2, forcing or causing the fuses to be the weakest link in the system only during the failure event described, resulting in a unintended reverse voltage and therefore safely removing the energy source from the battery management system providing a safe failure state. Another aspect of the present invention addresses the usage of fuses or other fusible properties of components (such as thin film resistors) along with the same uniquely applied switch theory to disconnect (such as forcibly disconnect) the energy source to the battery management system, also providing a safe failure state in situations or applications where the system manufacturer does not supply fuses for each cell voltage sense line, such as shown in FIG. 3. Each aspect of the present invention is unique in regards to the optimization of the number of fuses (fusible devices) affected upon the initial moment of system failure and the time to effectively disconnect the string of fuses (fusible devices).

Referring now to FIG. 2, a simplified system diagram of the BCECU (Battery Cell Electronic Control Unit) is connected to, for example, a 12 cell battery pack at 3.7V per cell with an additional 48V battery in series to simulate the full pack voltage, in accordance with the present invention. Capacitor C1 simulates the system Y capacitance, and resistors R1 and R16 simulate the BCECU impedance and resistor R15 is a static load in place of an inverter or DC-DC converter load. U1 through U13 is a prescribed fusing solution located in-line with the battery module wiring harness, but may also be located inside the battery system management module. The diode network with the specific purpose of fault handling during a reverse voltage scenario caused by a broken battery weld, high impedance cell or an incorrectly built wiring harness is designated by diodes D1 through D13. This concept covers the usage of a diode network arranged in a manner that is effective to prevent thermal runaway of the system by forcing the fuses or fusible devices to reside in a high impedance state (open circuit) in the event of an open cell, high impedance cell, broken bus bar (or weld) or an incorrect wire harness configuration, all of which will result in a reverse voltage seen by the BCECU.

The design configuration shown in FIG. 2 is unique for a few reasons. When the specified battery pack system failure mode occurs, a large reverse voltage is present across the battery pack break and the diode configuration is then biased such that it is engaging four fuses at the same time initially across the failed cell or weld, optimizing the effectiveness of overstressing fuses and minimizing the time to remove energy with a goal of blowing all fuses open but one. Once these four fuses blow open as intended, the adjacent diodes are forward biased and begin carrying current engaging the adjacent respective fuses and the reaction cascades outward until all of the alternate current paths are broken. Normally, it may be expected that one fuse will be left intact and this is acceptable due to all current paths/circuits are open.

In the event that the cell V1 or cell V12 experiences the failure mode, the result will be unique such that lowest fuse or the most upper fuse will need to be a broken or blown open circuit in order to stop the chain reaction. Breaking these fuses eliminates the differential voltages between all cells and the broken cell. In a scenario such as this, it is acceptable that only one fuse become open to remove the energy potential.

The invention shown in FIG. 2 may only be applied to a system with a fusible element already assumed in the battery pack/module design.

The invention in FIG. 3 is a solution if the OEM does not provide a fusing strategy. The fusing element described is a resistor of a thin film design or an equivalent fusible link which may be located inside of the BCECU. Although the operational principal of the design is similar as described in FIG. 2, the packaging of the solution may provide less system complexity and/or a cost saving to the OEM due to the elimination of fuses in the cabling.

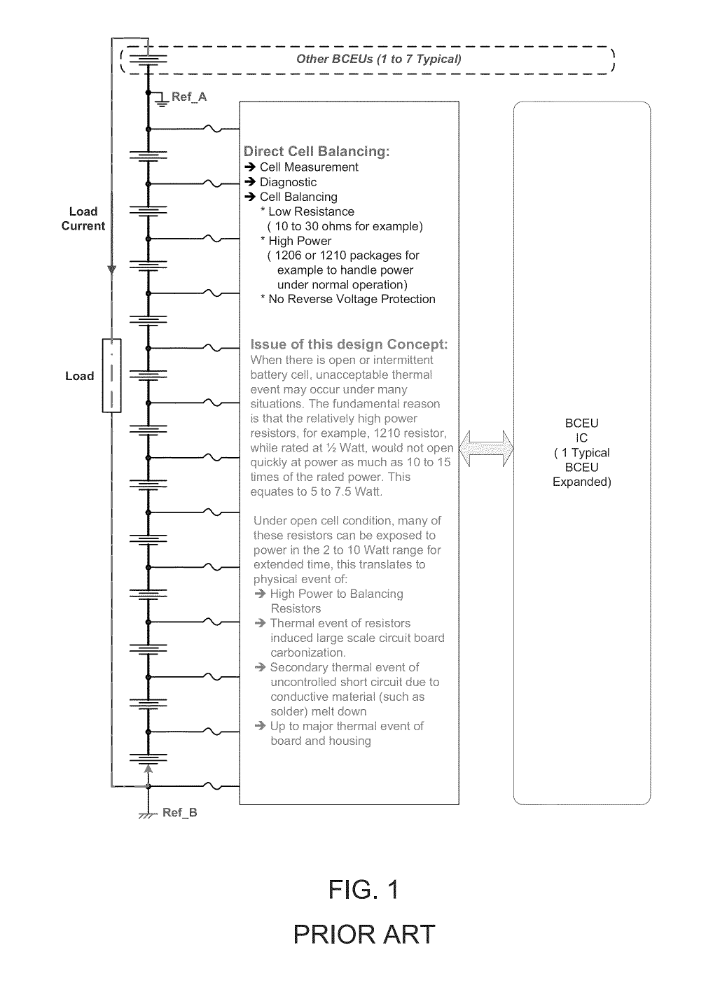

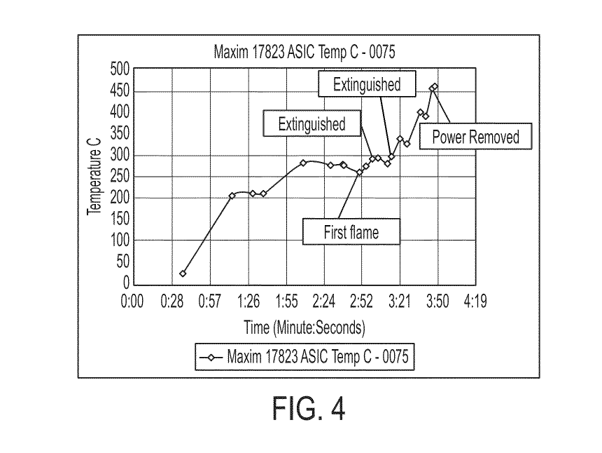

Initial testing has begun on the design described in FIG. 2. As a benchmark, the design described in FIG. 1 without a mitigation strategy has been tested with 0.5 A fusible links in the wiring harness with an active load current of 2 A. The benchmark design's thermal profile through the entire “Open Cell” test is described in FIG. 4. The maximum ASIC temperature reached was 463 degrees C. and thermal runaway was observed until human intervention was required to remove the source of energy.

The preliminary results with the design concept described in FIG. 2 has been tested with a load current of 3 A and the reaction has been limited to an ASIC temperature reaching about 51 degrees C. with a complete elimination of the thermal runaway event during the described failure mode. The module is also fully functional after the entire failure event. All fuses were opened except the lowest 2 A fuse for V1 as expected from the design theoretical simulation.

As discussed above, current known designs typically have an IC (integrated circuit) or ASIC (application specific integrated circuit) to directly turn on or off the Battery Cell Voltage Balancing Resistors, such as shown in FIG. 1. For products or systems with high balancing current requirements (such as over 50 mA for example), the balancing resistors typically need to be large in power capability and package size. For example, 1206 or 1210 surface mount resistors are typically used. When one or more battery cells is/are open, under various load conditions, the power to the balancing resistors can vary from no power to very high power.

The issue is that most resistors would stay as resistor under power as much as twenty times of rated power of the resistor. For example, a half Watt rated 1210 resistor would most likely stay as a resistor for a relatively long time (such as tens of seconds to minutes or longer) at about 7 Watts. When there are many resistors concentrated in a small area of a circuit board with excessive power, the resistors can reach very high temperature for extended time. This high temperature may be sufficient to cause significant thermal event leading to a fire on the PCB. The melted metals (such as solder of the resistor pads) can randomly move around creating unpredictable short circuits which can cause secondary random thermal events.

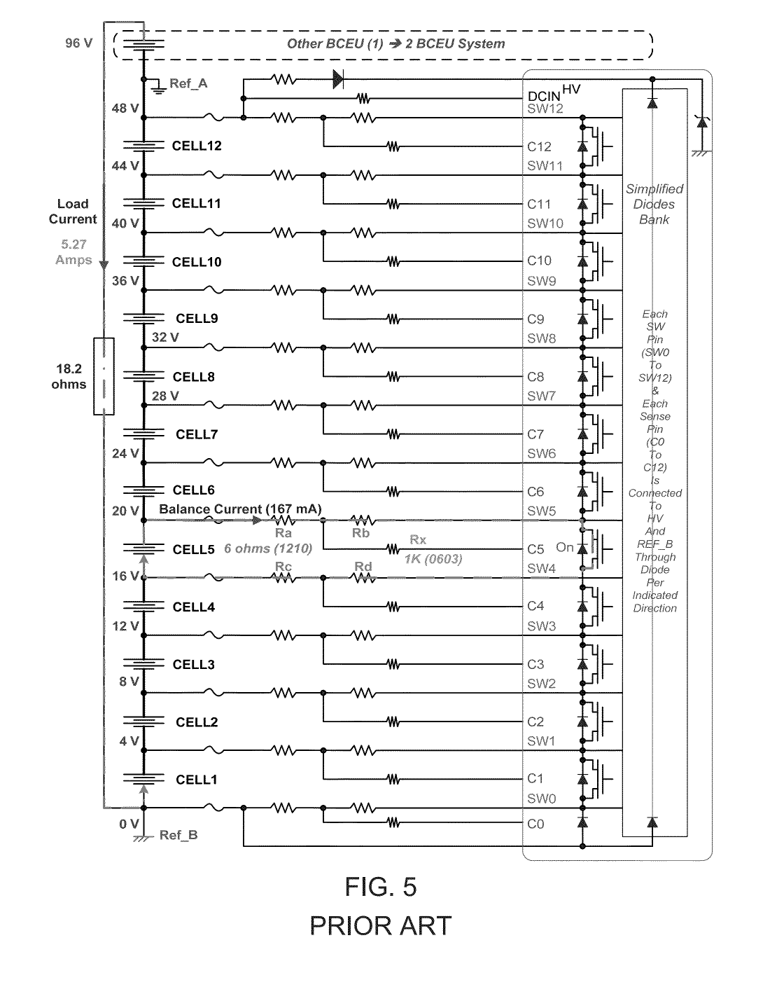

FIG. 5 is a simplified illustration of two-BCECU (Battery Cell Electronic Control Unit) battery management system with 12 battery cells per BCECU. This system is providing a load current of 5.27 Amps and at the same time is bleeding additional about 167 mA for CELL 5. Each battery cell voltage is typically around 3.7 Volts. When a certain cell voltage is deemed too high, the corresponding balancing switch is turned on. The cell under balancing would supply the balancing current in addition to the load current.

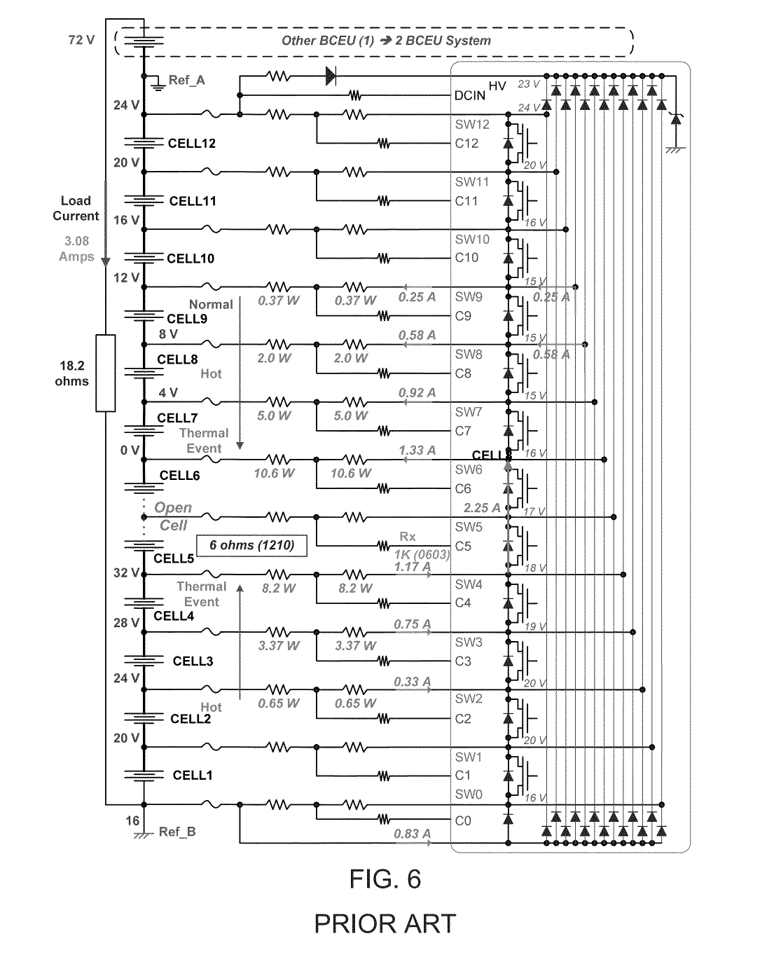

FIG. 6 is an illustration of what could happen when there is open battery cell (between CELL 5 and CELL 6 in this illustration). In this simplified case, all cells have 4 volts for ease of illustration. The internal structure of the IC is also simplified with a focus on internal diodes impact. When the battery cell connection is open, there are significant current flows through many of those balancing resistors. The total power of all the balancing resistors adds up to over 60 Watts in this illustration. The power to most of these balancing resistors is at or under 10 Watts. Most of these resistors would eventually carbonize along with the circuit board material instead of quickly opening, whereby a significant thermal event and possibly fire on the PCB and housing may be expected. Unless there is an effective countermeasure on the vehicle and a higher system level solution above the BCECU to localize and contain the thermal event, a countermeasure to reduce open battery cell induced BCECU failure mode severity is necessary.

The present invention provides a system that may significantly reduce the failure mode severity of a BCECU module under open battery cell condition.

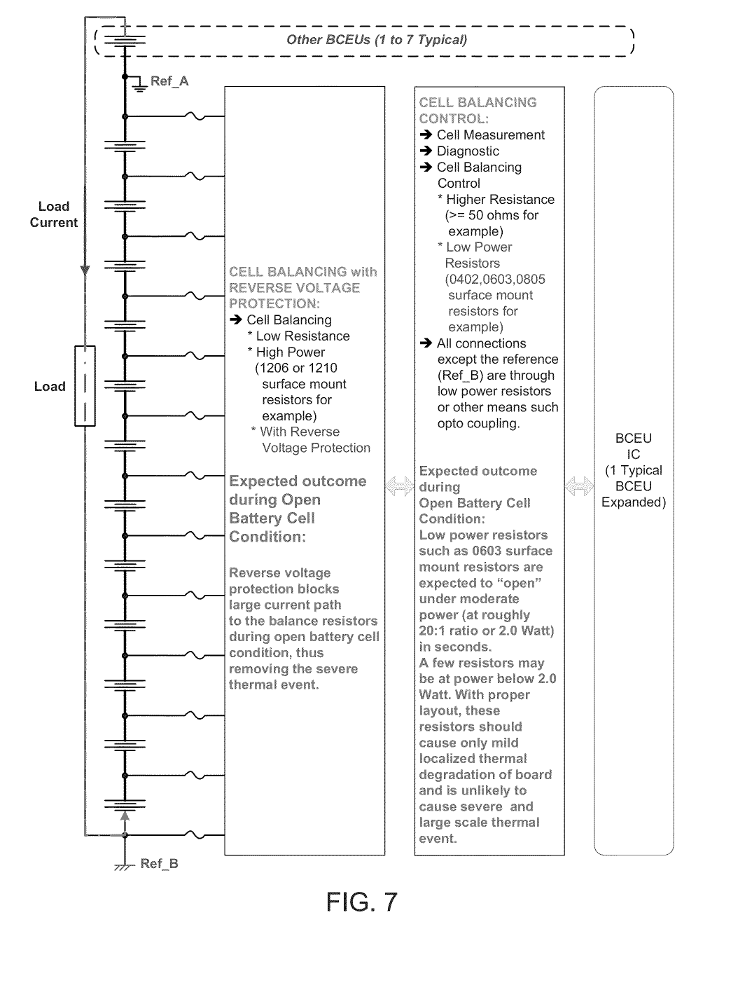

As shown in FIG. 7, instead of driving balancing resistors directly (which creates the severe failure mode during an open battery cell condition), the present invention may separate it in two stages: the first stage is cell balancing control and the second stage is cell balancing with reverse voltage protection.

In this approach, the cell balancing control no long requires high current (power) capability during normal operation. This makes it possible to use lower power components, such as small surface mount resistors (such as 0603 resistors, for example). Low or lower power components such as 0603 surface mount resistors (or the like) can act as “effective fuses” during an open cell condition. For example, a 0603 surface mount resistor typically will “open” under about 2 Watts power stress in approximately 10 seconds. If the power is higher than 2 Watts, the resistor will open faster. If the power is lower than around 2 Watts, with proper layout to localize the small resistor (to prevent secondary thermal event such as short circuit), the small resistors would have a limited level of local material carbonization (such as board carbonization).

The second stage is the actual cell balancing with reverse voltage protection. The reverse voltage protection stops or limits excessive current and power to the balancing resistors in the event of an open battery cell and is discussed in greater detail below using a concept example. Thus, the thermal stress induced under the approach of the present invention, with careful implementation including layout, should be contained within the BCECU housing.

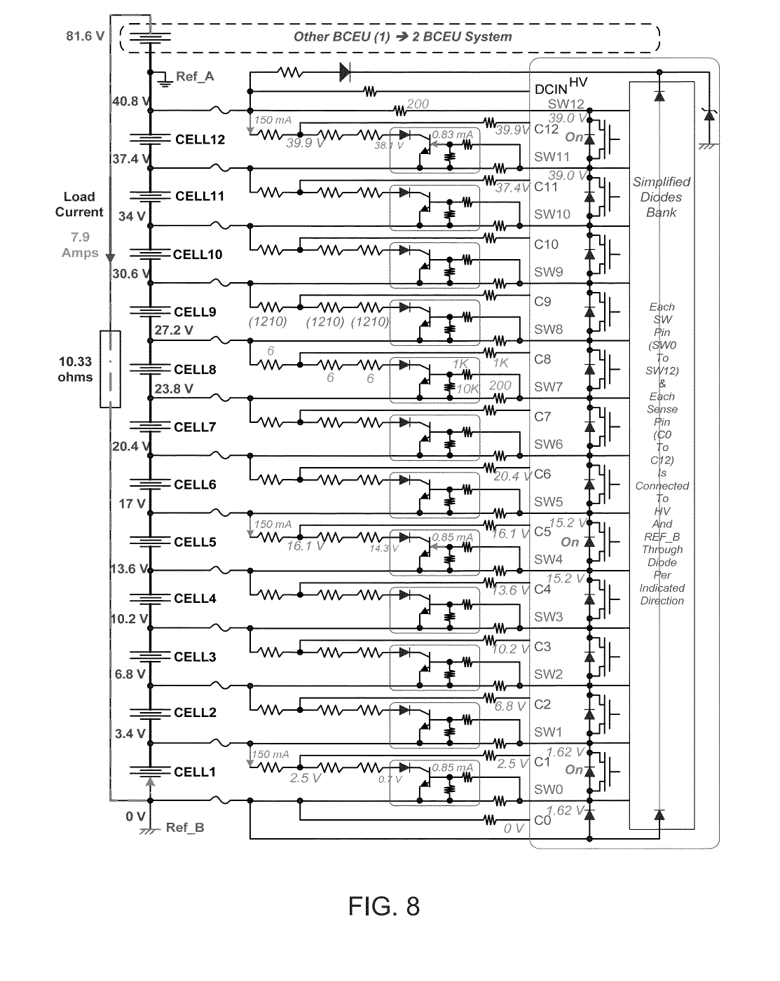

FIG. 8 illustrates an example design concept during normal cell balancing operation. In the illustrated embodiment, the system is driving about 7.9 Amps of load while providing balancing current for CELL 1, CELL 5 and CELL 12. Sense voltage C1, C5 and C12 are intentionally distorted from actual cell voltage to provide diagnostic capability of verifying that corresponding balancing transistors are on.

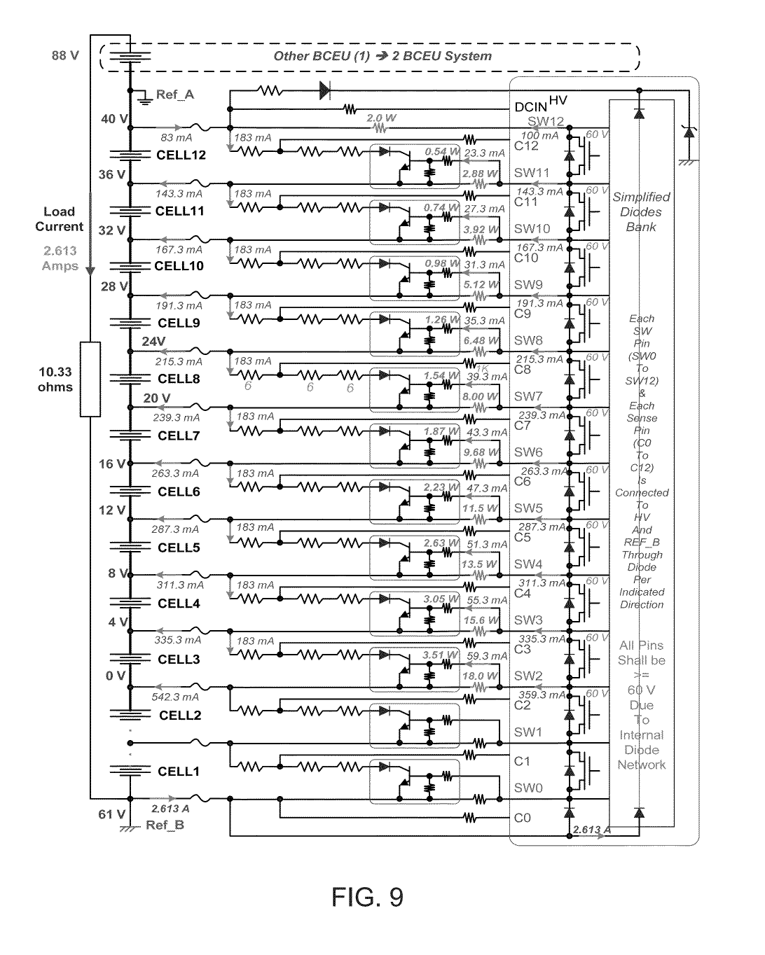

FIG. 9 illustrates the effect to the balancing control resistors' current and power during an open battery cell condition (the CELL 1 and CELL 2 connection is open in this illustration).

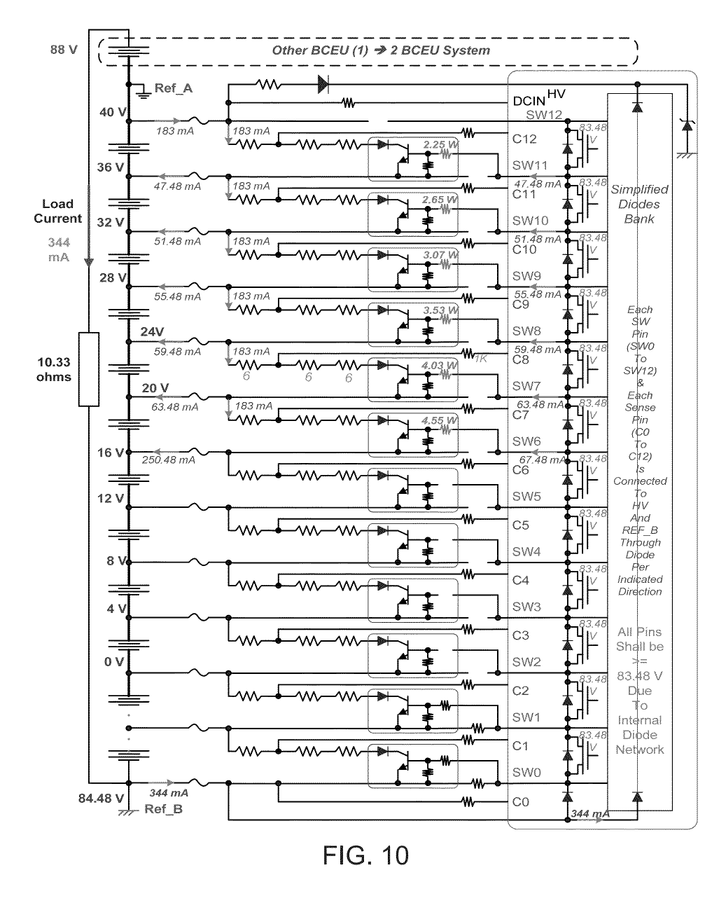

FIG. 10 illustrates what happens after all the balance control resistors over about 2 Watts in FIG. 9 become open circuits under thermal stress. The current and power to the remaining balancing resistors increase. These resistors become open subsequently also. In reality, balancing control resistors will go through a dynamic, multistage opening process. Resistors with highest powers over about 2 Watts will open first, which causes an increase in current and power to the remaining non-open resistors until all these resistors are preferably open. The fuses are assumed to be intact in this example, which is a reasonable assumption since the current through the fuses are expected to decrease quickly.

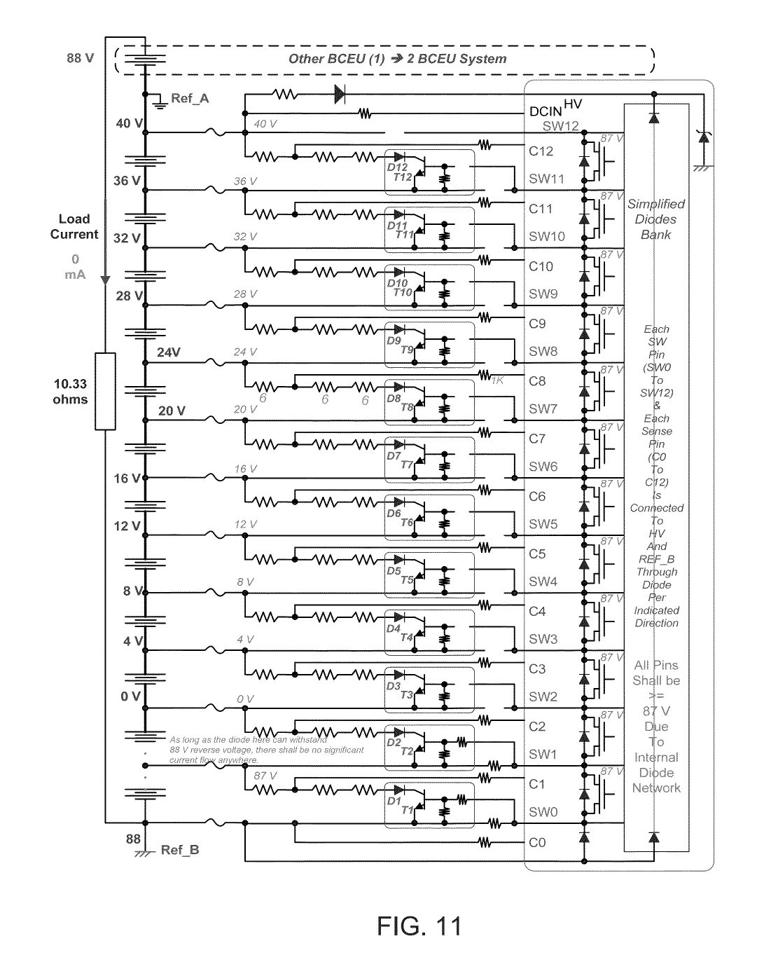

FIG. 11 illustrates what happens after all of the balancing control resistors outside of the open battery cells are open. In this case, as long as D2 is rated to hold up to about 87 volts of reverse voltage, all balancing switches (T1 to T12) are off either due to lack of base current or due to reverse bias. The sense resistor's impacts are not illustrated here for simplicity. Sense resistors (1 K) in this example are similar in value to the transistor base resistors (1 K) and will experience similar behavior as the transistor base resistors.

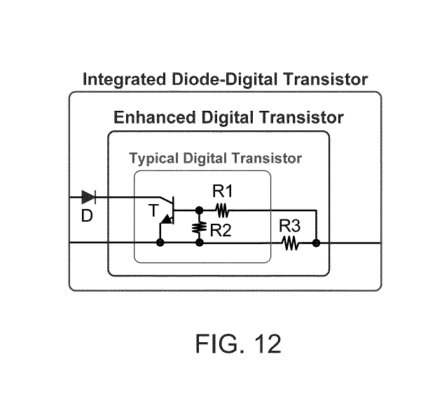

FIG. 12 shows how parts integration can be done to save part count and board space. A “Typical Digital Transistor” is readily commercially available. The “Enhanced Digital Transistor” can be easily manufactured by the addition of R3. An Integrated Diode-Digital Transistor can be manufactured by adding the Diode.

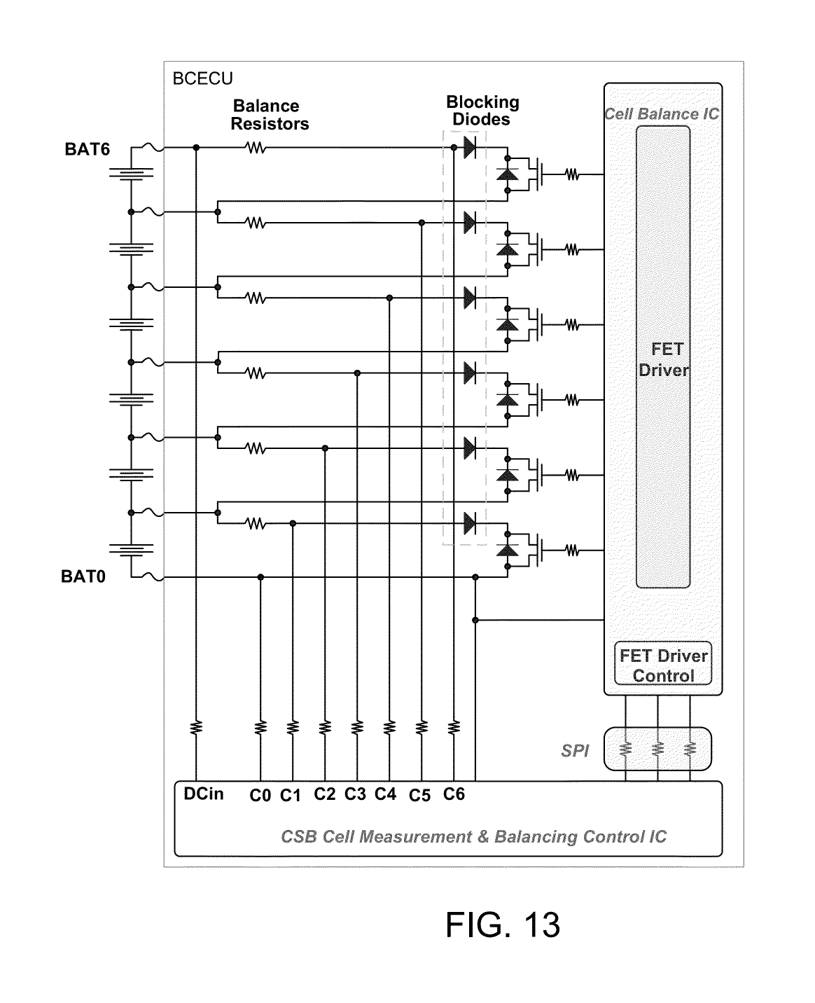

FIG. 13 shows that, in the event of open cell/high impedance failure mode, large current to Balance Resistors are blocked by blocking diodes. Only the balance resistors are high powered (multiple 1206 or 1210 resistors are typical for power dissipation). All other current must go through one or more lower power (such as 0603) resistors. Since 0603 resistors are effective to mitigate thermal degradation with proper layout consideration, risk of significant thermal event is mitigated. Thus, reverse current paths are blocked which would otherwise result in an unintended large reverse current in the event of an open cell/high impedance failure. In turn, low current, lower power paths are mitigated from a major thermal event with low power resistors with proper layout.

Therefore, the present invention provides a battery management system that at least one of (a) forces the fuses to be the weakest link in the system only during a failure event and thus safely removes the energy source from the battery management system providing a safe failure state, (b) disconnects or forcibly disconnects the energy source to the battery management system to provide a safe failure state, such as in situations or applications where the system manufacturer does not supply fuses for each cell voltage sense line, (c) separates the driving of balancing resistors into two stages: the first stage comprising cell balancing control and the second stage comprising cell balancing with reverse voltage protection and (d) provides single stage reverse voltage protection, effectively eliminating an electrical conduction path through a low impedance balancing circuit.

Changes and modifications in the specifically described embodiments may be carried out without departing from the principles of the present invention, which is intended to be limited only by the scope of the appended claims as interpreted according to the principles of patent law.

1. A battery management system for a vehicle having an electrically powered motor that is powered by a plurality of battery cells, the battery management system comprising:
an electrical system for providing voltage and current from a plurality of battery cells to an electrical motor; and
a control that is operable to at least one of (a) cause fuses of the electrical system to be the weakest link in the electrical system only during a failure event, (b) disconnect the plurality of battery cells from the battery management system only during a failure event, (c) separate the driving of balancing resistors of the electrical system into first and second stages, with the first stage comprising cell balancing control and the second stage comprising cell balancing with reverse voltage protection and (d) provide single stage reverse voltage protection to limit an electrical conduction path through a low impedance balancing circuit of the electrical system.

2. The battery management system of claim 1, wherein the control is operable to cause fuses of the electrical system to be the weakest link in the electrical system only during a failure event.

3. The battery management system of claim 1, wherein the electrical system comprises cell voltage sense lines for determining a voltage level at the battery cells, and wherein the control is operable to cause fuses of the cell voltage sense lines to be the weakest link in the electrical system only during a failure event to effectively disconnect the battery cells from the battery management system.

4. The battery management system of claim 1, wherein the control is operable to disconnect the plurality of battery cells from the battery management system only during a failure event.

5. The battery management system of claim 4, wherein the electrical system comprises cell voltage sense lines for determining a voltage level at the battery cells, and wherein the electrical system does not include fuses at the cell voltage sense lines.

6. The battery management system of claim 1, wherein the control is operable to separate the driving of balancing resistors into first and second stages, with the first stage comprising cell balancing control and the second stage comprising cell balancing with reverse voltage protection.

7. The battery management system of claim 1, wherein the control is operable to provide single stage reverse voltage protection to limit an electrical conduction path through a low impedance balancing circuit of the electrical system.

8. The battery management system of claim 7, wherein the control provides single stage reverse voltage protection to effectively eliminate an electrical conduction path through the low impedance balancing circuit.

9. A battery management system for a vehicle having an electrically powered motor that is powered by a plurality of battery cells, the battery management system comprising:
an electrical system for providing voltage and current from a plurality of battery cells to an electrical motor;
wherein the electrical system comprises a plurality of fuses; and
wherein the control is operable to cause at least some of the fuses of the electrical system to be the weakest link in the electrical system only during a failure event.

10. The battery management system of claim 9, wherein the electrical system comprises cell voltage sense lines for determining a voltage level at the battery cells, and wherein the plurality of fuses comprise cell sense line fuses disposed at the cell voltage sense lines.

11. The battery management system of claim 10, wherein the control is operable to cause the cell sense line fuses of the electrical system to be the weakest link to effectively disconnect the battery cells from the battery management system.

12. The battery management system of claim 9, wherein the control is operable to separate the driving of balancing resistors into first and second stages, with the first stage comprising cell balancing control and the second stage comprising cell balancing with reverse voltage protection.

13. The battery management system of claim 9, wherein the control is operable to provide single stage reverse voltage protection to limit an electrical conduction path through a low impedance balancing circuit of the electrical system.

14. The battery management system of claim 13, wherein the control provides single stage reverse voltage protection to effectively eliminate an electrical conduction path through the low impedance balancing circuit.

15. A battery management system for a vehicle having an electrically powered motor that is powered by a plurality of battery cells, the battery management system comprising:
an electrical system for providing voltage and current from a plurality of battery cells to an electrical motor;
wherein the electrical system comprises cell voltage sense lines for determining a voltage level at the battery cells; and
a control that is operable to at least one of (a) disconnect the plurality of battery cells from the battery management system only during a failure event, (b) separate the driving of balancing resistors of the electrical system into first and second stages, with the first stage comprising cell balancing control and the second stage comprising cell balancing with reverse voltage protection and (c) provide single stage reverse voltage protection to limit an electrical conduction path through a low impedance balancing circuit of the electrical system.

16. The battery management system of claim 15, wherein the electrical system does not include fuses at the cell voltage sense lines, and wherein the control is operable to disconnect the plurality of battery cells from the battery management system only during a failure event.

17. The battery management system of claim 16, wherein the control is operable to disconnect the plurality of battery cells from the battery management system only during a failure event to effectively disconnect the battery cells from the battery management system.

18. The battery management system of claim 15, wherein the control is operable to separate the driving of balancing resistors into first and second stages, with the first stage comprising cell balancing control and the second stage comprising cell balancing with reverse voltage protection.

19. The battery management system of claim 15, wherein the control is operable to provide single stage reverse voltage protection to limit an electrical conduction path through a low impedance balancing circuit of the electrical system.

20. The battery management system of claim 19, wherein the control provides single stage reverse voltage protection to effectively eliminate an electrical conduction path through the low impedance balancing circuit.
